(19) United States
(12) Patent Application Publication
(10) Pub. No.: US 2009/0312860 A1
(43) Pub. Date: Dec. 17, 2009

(54) METHOD FOR AUTOMATED CREATION AND DISPLAY OF ASSEMBLY DOCUMENTATION FOR CUSTOM HEARING AID MANUFACTURING

(76) Inventors: Roland Beucker, Nuernberg (DE); Giorgi Ediberidze, Nuernberg (DE); Sarah Nadine Eigner, Nuernberg (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/477,537

(22) Filed: Jun. 3, 2009

Related U.S. Application Data
(60) Provisional application No. 61/058,630, filed on Jun. 4, 2008.

(51) Int. Cl. G06F 19/00

(52) U.S. Cl. 700/107

(57) ABSTRACT

A method for updating manufacturing documents with changes in bill of materials information includes generating and storing the manufacturing documents including wiring diagrams and the like in a standard format, such as a PDF document, but without including the bill of materials information in the manufacturing document. The bill of materials information is generated and stored separately, either as a document or as a master list, for example. The manufacturing document and bill of materials information is linked. Updates to the bill of materials information is entered without requiring changes in the corresponding manufacturing document or creation of new PDF documents showing the wiring diagrams and the like. The linked documents are displayed on a screen on a manufacturing floor.

### CROSS-REFERENCE TO RELATED APPLICATION

The present application claims the benefit of U.S. Provisional Patent Application Ser. No. 61/058,630, filed on Jun. 4, 2008, which is incorporated herein by reference.

### BACKGROUND OF THE INVENTION

1. Field of the Invention

The present invention relates generally to a method for creating and displaying assembly documentation for manufacturing, and in particular to a method for creating and displaying assembly documentation for manufacturing custom hearing aid devices.

2. Description of the Related Art

A hearing aid is an electronic device worn either behind the ear or in the ear of a hearing impaired person to amplify sound or otherwise change a characteristic of the sound. In-the-ear type hearing aids are often customized to the wearer due to the great variation in ear canal shapes and sizes. These in-the-ear hearing aids are made using both standard components and highly customized components that depend on patient needs and ear configuration, for example. It is necessary to provide many different manufacturing plans for manufacturing each of the different customized hearing aids.

Among the companies which produce hearing aids, Siemens Audiologische Technik GmbH (SAT) produces in-the-ear-hearing aids (also referred to as ITE products or custom products) and behind-the-ear hearing aids (referred to as BTE products). The ITE (in the ear) products are sold on the worldwide market and consist of both standard and highly customized components. The combination of various product options, product lines, and customer-specific components leads to a very large number of product variants to maintain.

For the large number of different variants to be produced on the manufacturing floor, specific manufacturing related documents for each variant are required. In the currently practiced process, the manufacturing documents are created manually and therefore a substantial maintenance effort is required as a consequence. For this reason, it would be beneficial of a new process were developed to simplify the document management process.

The current practice for the manufacture of custom hearing aid devices includes utilization of a global Product Lifecycle Management (PLM) solution, or computer program or system, which has the following main functionalities: project management; management of product families; product management; parts management; bill of materials (BOM) management; document management; and change management. Each of these is a data object in the product lifecycle management program. The main managed objects are projects, parts, bill of materials, documents, and engineering change orders (ECOs) and the relationships between these data objects. Design projects are also managed within the PLM system for structuring data and activities.

With a real-time interface, the data that is relevant to production is transferred to an enterprise resource planning (ERP) system. Since the document management functionality and the change management functionality take place in the PLM system, all documents have to be released before they are transferred to the ERP system.

The process for production of custom hearing aids presents a number of problems since an in-the-ear-hearing aid is a very complex and customer-specific product. For manufacturing these devices, several steps are required. The base of an in-the-ear hearing aid is referred to as a faceplate. A hybrid component is added on to the faceplate in a stage of the manufacturing process referred to as a faceplate pre-assembly (FPP) step. A receiver and a microphone are added to the faceplate pre-assembly to form a final faceplate (FFP).

To build the faceplate pre-assembly and the final faceplate assembly, the production floor of the factory needs specific documents with the wiring diagram for the device and the bill of materials as information for the parts shown on the wiring diagram.

For easier viewing and print-out, the current practice requires that the wiring diagram and the bill of materials are provided on one page. The wiring diagram is created by a drawing tool or drafting program operated on a computer and the bill of materials is created by manual entry of the information into a spreadsheet on a computer. These elements are created without any link to the PLM system. The wiring diagram and the bill of materials information are merged in a computer onto a single page of data, and after being merged together, the page of data is converted to a document format for easy exchange and viewing on many different computer displays, for example the in the PDF (portable document format) format of the Adobe Acrobat program. One page of data is generated for each variant of the hearing aid products.

The disadvantage of the existing method lies in the effort expended for the manual creation of each document and the significant effort that is involved in case there is a change. For example, the manufacturer may determine to change a particular part for a part from a different supplier. The new part may have a different designation or part number. In one example, a wire used in the manufacture of some variants of the hearing aids and listed on the bill of materials for these hearing aid variants is changed to a different wire having a different designation for future manufacture of these hearing aides. This change is generally applied not just to one product model but to a number of variants in the product line. Every time there is a change made in the bill of materials of a product family, all of the documents of that product family are affected and the affected documents have to be generated in updated form to include the change. The generation of these updated documents is very time consuming and is prone to errors.

### SUMMARY OF THE INVENTION

The present invention provides a method for generating and for using manufacturing documents for customized products, and in particular for manufacturing custom in-the-ear hearing aid devices using manufacturing documents that are subject to being updated. All or nearly all production floors in a manufacturing facility have display screens on which can be displayed computer data. As such, there is no longer a requirement to have the bill of material listing for a manufacturing document and the schematic diagram, for example a wiring diagram, for that manufacturing document merged together on one data page. The present method provides for maintaining the bill of material information and the corresponding schematic diagram as separate but linked documents in the computer system without generating a single document containing both. Updates to materials in the bill of materials information can be made in the bill of materials component without the need for generating new manufacturing documents that include the diagrams.

The present invention provides an efficient and timesaving process for the creation and display of manufacturing documents. The information which is relevant and which must be displayed for the workers on the production floor is the wiring diagram and the bill of materials. According to the present method, the two pieces or items of information, the wiring diagram and bill of materials information, is available to the production personnel separately. The method provides that although the information is separate, it is always clear which bill of materials information belongs to which wiring diagram.

According to the present method, it is not longer necessary to create manufacturing documents which contain the bill of materials information. Instead only the wiring diagram or other schematic diagram or drawing needs to be created and released as its own document. For example, the wiring diagram is created in a PLM (Product Lifecycle Management) computer system. The documents are transferred to the ERP (enterprise resource planning) computer system, for example, for storage along with other documents.

Based on a production order or on a customer order, the production workers in the operations or production facility are easily be able to access the bill of materials information and to view an exploded view of the bill of materials information as well as to view the wiring diagrams, either online, by using the ERP system front end, or offline. The exploded bill of materials information and the wiring diagram are displayed in two separate windows on a display screen. For example, the employee on the manufacturing floor accesses the schematic diagram for viewing on a display screen and is able to view the linked bill of materials information on that screen as a separate window, or may view the bill of materials information on another screen.

### BRIEF DESCRIPTION OF THE DRAWINGS

FIG. 1 is a manufacturing document according to the prior art as used in manufacturing of a hearing aid, the document including a wiring diagram or schematic and a bill of materials listing;

FIG. 2 is a screen shot of a display screen showing a manufacturing document according to the principles of the present invention including a wiring diagram for manufacture of a hearing aid but lacking a bill of materials integrated into the document;

FIG. 3 is screen shot of a bill of materials listing for the wiring diagram of FIG. 2;

FIG. 4 is a flow chart of a method for generating manufacturing documents according to the principles of the present invention; and

FIG. 5 is a process flow chart for using the manufacturing documents of the present invention.

### DETAILED DESCRIPTION OF THE PREFERRED EMBODIMENTS

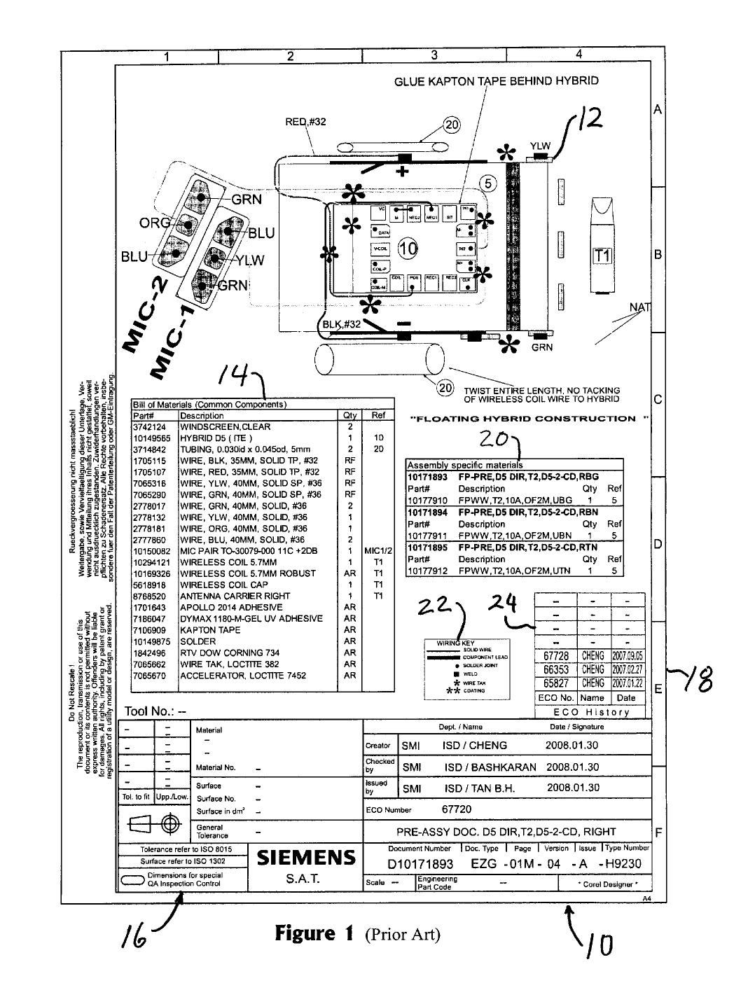

FIG. 1 shows a manufacturing document 10 as used in the manufacture of a custom in-the-ear hearing aid. The manufacturing document 10 can be printed on paper or shown on a display, such as on a display screen of a workstation on a manufacturing floor where the hearing aid is being manufactured. The display screen can also be located in a management, engineering, or design department or other location. The manufacturing document 10 includes a schematic diagram or wiring diagram 12 showing the device to be manufactured. The schematic diagram has been prepared using a computer-aided drafting (CAD) program or other drawing or graphics program and has been incorporated into the manufacturing document 10. The manufacturing document also has a bill of materials 14 incorporated into the document which includes of a listing of parts with part numbers, quantities and descriptions for the parts used in constructing and/or assembling the device shown in the schematic diagram 12. The bill of materials 14 has been created in a text-based program and has been inserted into or incorporated into the manufacturing document 10. The manufacturing document 10 also includes a title block 16 that includes such information as the company name, document number and version, document creator, checker and issuer and a device identifier. A bounding border 18 surrounds the document 10 and provides coordinates for locating information on the document (i.e., 1-4, A-F) as well as copy information. Also in the document are provided an assembly specific materials block 20, a wiring key block 22 and an engineering change order (ECO) block 24. Three engineering changes are listed.

The components of the manufacturing document 10 have been created using programs, such as the computer-aided drafting program for the schematic diagram 12 and a text editor, word processor, spreadsheet, or other text-based program for the bill of materials block 14 and possibly for other blocks of the drawings. The data from these programs is merged into a single document that is either prepared in or converted to a format for storage, printing and viewing on the wide range of computer devices. For example, the manufacturing document 10 is typically converted to a PDF (portable document format) file format developed by Adobe Systems and which allows the document to be represented in a manner independent of application software, hardware and operating system.

A separate manufacturing document 10 is prepared for each variation of the hearing aid, for each model and for each style or configuration. Ears may be as unique as fingerprints, resulting in many variations in shape, size and design. Due to the custom nature of the in-the-ear hearing aides a large number of different models and variations of hearing aides must be available for manufacture to meet the needs of the wearers, and thus a large number of manufacturing documents is created. For example, thousands of manufacturing documents may be require to provide a full range of the hearing aids. The manufacturing documents 10 are stored on a computer readable media, such as a computer hard drive or the like, for access and viewing over a computer network, for example, by the workstation.

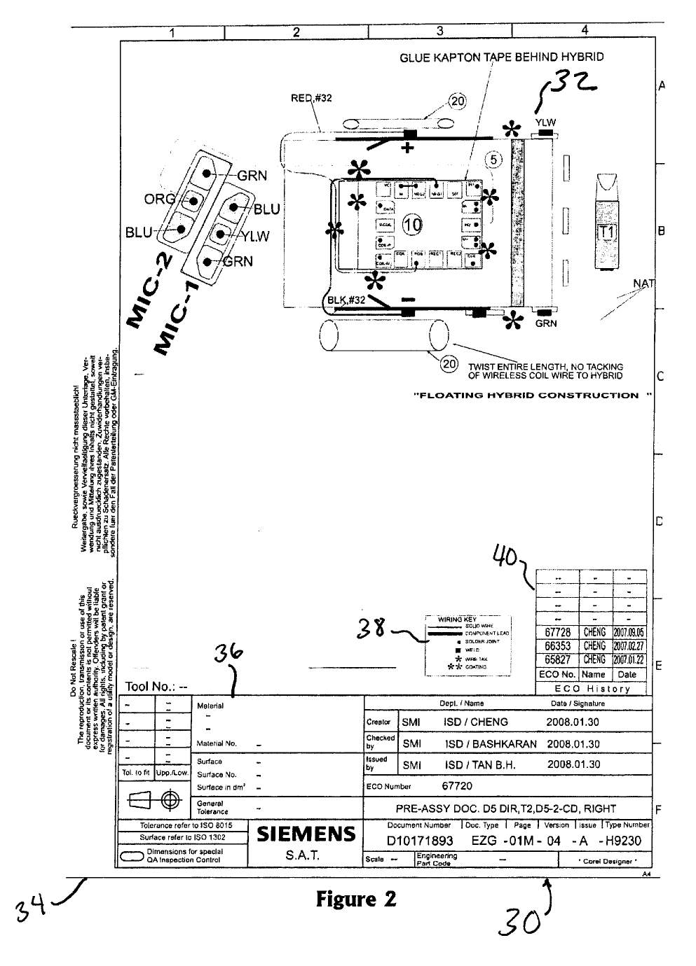

FIG. 2 shows a manufacturing document 30 according to the present method. The manufacturing document 30 includes a schematic or wiring diagram 32 for the same variation of device shown in FIG. 1. The schematic diagram 32 is prepared using a computer-aided drafting program, drawing program or other graphics program. The manufacturing document 30 also has a bounding border 34, title block 36, wiring key 38 and engineering change order block 40. These elements are created in the same or a similar manner to that for the manufacturing document 10 of FIG. 1. The exception is that the bill of materials information is not added to the document or otherwise merged into the document. The manufacturing document 30 is converted to a format, such as PDF, for storage on network accessible computer readable media and display on workstations on the manufacturing floor or other computer terminals at other locations.

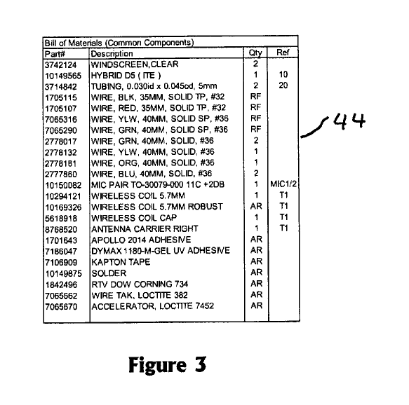

As shown in FIG. 3, a bill of materials block 44 is provided as separate information from the schematic diagram manufacturing document 30. The bill of materials block 44 lists the part descriptions, part numbers, quantities and potentially other information for the parts and components used in assembling the device shown in the schematic diagram manufacturing document 30. The parts information identify characteristics of the parts that be may subject to change and by keeping the bill of materials information separate that information may be more easily changed. The information in the bill of materials is presented in table or list form on the display screen. The information may be stored in table or list form on the computer readable media, or may be stored in some other format, such as by links to a master list, or other known format.

The bill of materials list 44 corresponding to the schematic diagram in the manufacturing document 30 may be created using a text-based program, such as a spreadsheet program or word processor program. The text-based program may be a component of a suite or group of programs, such as an office suite or technical writing program. Once created, the bill of materials 44 may be saved in a text-based format file on a network storage device or other computer readable media. Alternately or in addition, the bill of materials may saved as a PDF file format on the storage device. The bill of materials 44 may instead be created as a list of links that link to part descriptions and characteristics, so that each time the list is called or displayed, the links pull the descriptions from a master list. In what ever form, the bill of materials file or data 44 is saved with other bill of materials information files or data for other designs on the computer readable storage device.

The bill of materials 44 is linked to the corresponding manufacturing document 30 by a link that enables one to be accessed when the other is accessed. The link may be provided in a document management system or may be saved with or otherwise associated with the files 30 and 44.

Personnel on the manufacturing floor may call up the bill of materials 44 while working on or preparing to work on the particular variant of the device for which the bill of materials is provided. The bill of materials 44 may be retrieved first, or may be retrieved after the corresponding schematic diagram manufacturing document 30 has been called. A link is provided so that when one document (either the schematic diagram document or the bill of materials information) is opened, the other document may be opened simply by selecting or activating the link. One or the other of the files may be displayed separately as well, without calling the linked document. The bill of materials information 44 and manufacturing schematic 30 may be displayed on the same display device, for example in separate windows of a graphical user interface or by alternately displaying each for example in a full screen view. It is also possible to display the bill of materials 44 on one display device and the manufacturing schematic 30 on another display device. These can also be printed. The bill of materials information is not fixed, but is retrieved and displayed as a list as needed. The bill of materials is dynamically generated. The displayed list permits the user to automatically drill down for further information.

In another embodiment, the bill of materials information 44 is merged into the manufacturing document 30 when the linked documents are called, or at some later time, so that the combined document can be displayed and/or printed. The merging step may be performed automatically or the merge may be selectively performed for example following a user request. The difference over the prior practice is that the merging of the information is performed when the merged documents are to be used, rather than following initial creation of the document or creation of a changed or updated document.

Should a change in one or more of the materials used in the manufacture of the device be desired, the change can be made by performing a search and replace operation through the bill of material files, replacing the prior material or part with an updated material or part. This search and replace is a “where used” search to identify each product that uses the material that is subject to the change. In a preferred embodiment, the “where used” function is performed automatically by the system. In one example, a wire of a particular material, make, characteristic, or from a particular source as used in the original manufacturing design is to be replaced by a wire of a different material, make, characteristic or source. The original wire is to be replaced with the updated wire at every instance in every design or variation where it appears in custom hearing aide designs. This may involve very large numbers of manufacturing documents for the different designs effected by the change. Using the present method for updating the bill of materials information simplifies what may have required changes to potentially hundreds of manufacturing documents.

Changes in the bill of materials information are preferably tracked by dates, wherein each bill of materials has a date associated with the information of the most recent update. The system may also track update history information as well. This permits a user to view forward and backward changes in the bill of materials information. For production, only the current bill of materials information is to be used. This provides a time lead system.

Changes in the bill of materials information are generally required more frequently than changes in the wiring diagrams or other manufacturing diagrams. Wiring changes are seldom required in established designs. The source of a material or part, or some part characteristic or designation may change with far greater frequency, however, so that the present method permits these changes to be made without calling up and changing each of the diagrams. The reduced workload resulting from elimination of the need to update each effected manufacturing document results in greater efficiency for a plant, as well as reduced likelihood of errors.

The process of changing one or more parts in the bill of materials 44 includes steps of searching the bill of material data for the original part and replacing the original part in the data with the new part. In systems that use a link list to pull part descriptions from a master list each time the bill of material is displayed, the original part information need only be replaced with the new part information on the master list. The change in materials only needs to be entered once. The link list remains unchanged. Each time a bill of material is displayed that contains this part, the new part is show in place of the original part.

Updates are particularly easy. In systems that use a text-based file for each parts list, the text files on the storage device are searched and the new part is replaced into the text-based file for each instance of the original part in the bill of material files. Search and replace functions for doing this are well known. Updates are also quite easy to accomplish. In systems using PDF or similar file formats for the bill of materials files, the bill of materials files for each effected design are changed and are converted to PDF format for saving on the storage device. Even in this system it is not necessary to access the schematic drawing data and recreate the entire manufacturing schematic for each part change since only the bill of materials file is changed.

The present method may be part of a production system in which each of the documents for producing a product, such as a custom product, are linked to one another and can be called for display by selecting links. For example, a customer order or production order may be linked to the bill of materials file and/or to the manufacturing document or wiring diagram. The user of the workstation can navigate through the linked files. Here, a distinction is made between a customer order and a production order. A customer order is for manufacture of one or several devices as requested by a customer. The customer may be an individual in need of a single hearing aid, or a company or organization ordering one or several hearing aids. A production order is a request by the company to fill or refill stocks of one or more products, not necessarily in response to customer orders. When an order arrives at the factory, the corresponding bill of materials data and wiring diagram can be called up by selecting the links.

The bill of materials information 44 may be exploded, such as by selecting parts on the bill of materials list using a mouse or other computer pointer, to see additional information on the selected part or parts. This enables the user to “drill down” for additional information on the selected item. The wiring diagram may be exploded as well. Additional information on the parts is available in the exploded view. The exploded view may be exploded as a result of selection by the user or the display may show the exploded view by default. The exploded view preferably shows all of the parts and provides all of the information on all of the parts including all levels of information on the materials.

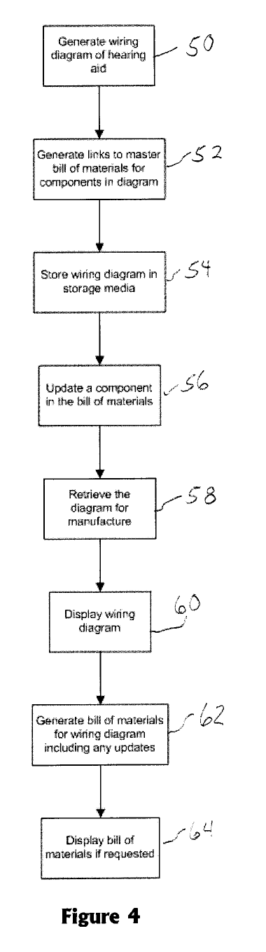

In a method according to the present invention, as shown in FIG. 4, a first step 50 is to generate a wiring diagram of a hearing aid device. For the components shown or identified in the diagram, links are generated to a master bill of materials list or database, as in step 52. The wiring diagram is stored in or on a storage medium in step 54, such as a computer readable media. Where a change is to be made in the materials used for manufacture of the hearing aid, an update is made of a component in the bill of materials, in step 56. This is accomplished without changing the wiring diagram or generating new wiring diagram documents.

When it is desired to manufacture the hearing aid according to the diagram, step 58 is performed wherein the diagram is retrieved for manufacture. In step 60, the wiring diagram is displayed. The bill of materials for manufacture of the hearing aid according to the wiring diagram is generated in step 62. The bill of materials information includes any updates that were entered, for example, at step 56. The bill of materials information is displayed in step 64 if requested.

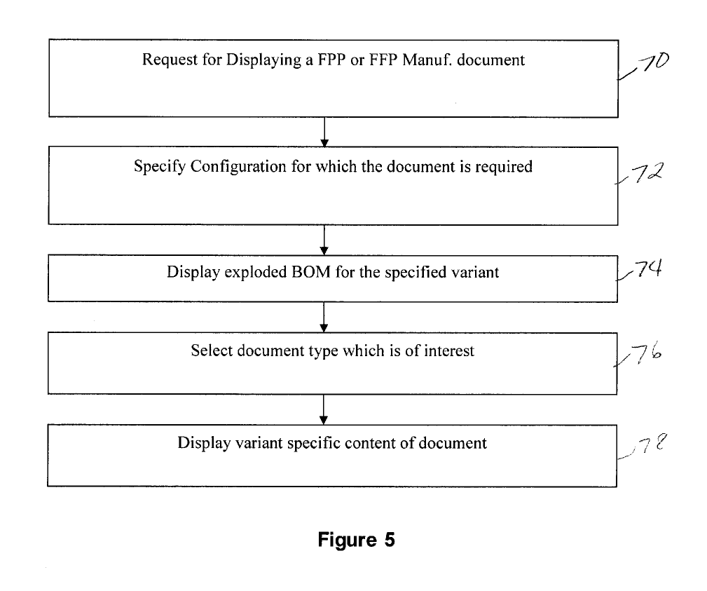

FIG. 5 shows a further method, including the steps of requesting a display of an FPP or FFP manufacturing document at step 70. In step 72, the configuration for with the document is required is specified. The bill of materials (BOM) information for the specific variant device is displayed according to step 74. The document type which is of interest is selected in step 76. In step 78, the variant specific content of the document is displayed.

Additional features include creation of manufacturing documents using the stored data. If the user desires to have the wiring diagram and the bill of materials information on the same page, for example for easier viewing, the combination of the two stored items is provided by including one additional step. The bill of materials information that has been retrieved from it's storage location, and which potentially has been updated with new materials information, and the wiring diagram or other manufacturing diagram has been retrieved from it's storage location. These two items are merged into one document for display and/or for printing. It is assured that the bill of materials information is current and included update information.

Based on the fact that the bill of materials information and the wiring diagram are available as separate data objects, the merging process step combines the two separate pieces of information into one file which is displayed to production personnel identically to today's manufacturing documents. The manufacturing personnel thereby see familiar documents but with the latest information.

The user may specify a configuration of the hearing aid or other device for which the documentation is required. The user may display an exploded bill of materials for the specified variant. The user selects the document type which is of interest and a variant specific content of the document is displayed.

The manufacturing process utilizes the displayed information. If the bill of materials information is separated from the wiring diagram, the user can navigate from the production order or customer order to the exploded order bill of materials. The exploded order bill of materials can be displayed on a monitor of a workstation, printed out or otherwise viewed. Starting with an order, the user can navigate to the header material of the order. From there, the user can navigate to all linked documents. The maintenance effort will be reduced, because of the following reasons: There is no requirement for merging of the bill of materials information and wiring diagram on one page. In case of a bill of materials change, no manufacturing documents needs to be changed. Only the bill of materials information has to be changed, for example in the PLM system. After the transfer, the most recent bill of materials information will be shown automatically.

The present method thereby provides an improvement over the history based practices which used printouts to accommodate production floors that lacked display screens for viewing manufacturing documents. The printouts provide the wiring diagram and bill of materials information on a single page for viewing and manufacturing. However, since today most of the manufacturing sites have display screens they can easily display the bill of materials and wiring diagram as separate documents. This will reduce the effort for documentation creation during the development phase. In case of engineering change requests there are no actions required regarding documentation update because bill of materials information is maintained separately and the display of the bill of materials is manufacturing order dependent, the actual bill of materials information for the particular order is used. It is anticipated that little training effort will be required as it is expected that the users will easily adapt to the new process. Further advantages are the shorter time to react to changes and better quality of the documentation.

Although other modifications and changes may be suggested by those skilled in the art, it is the intention of the inventors to embody within the patent warranted hereon all changes and modifications as reasonably and properly come within the scope of their contribution to the art.

We claim:

1. A method for creation and display of documents for manufacture of a custom hearing aid, comprising the steps of:
generating a schematic diagram of a custom hearing aid to be manufactured;
generating a manufacturing document including the schematic diagram but lacking a bill of materials;
saving the manufacturing document to a computer readable media;
generating bill of materials information corresponding to parts used in manufacturing of the custom hearing aid shown in said schematic diagram;
linking said bill of materials information to said manufacturing document; and
saving said bill of materials information to a computer readable media as a separate file from said manufacturing document.

2. A method for updating a manufacturing document; comprising the steps of:
retrieving an existing manufacturing document for a predetermined device to be updated from a computer readable storage media, said existing manufacturing document including a wiring diagram and a bill of materials together in a single document;
generating a wiring diagram for the predetermined device as a separate document from bill of materials information;
generating bill of materials information for the predetermined device, said bill of materials information being separate from said wiring diagram;
storing said wiring diagram as a document on a computer readable media separate from said bill of materials information; and
linking said wiring diagram document and said bill of materials information as linked information.

3. A method as claimed in claim 2, wherein said predetermined device is a custom hearing aid.

4. A method for creating a manufacturing document, comprising the steps of:
creating a manufacturing diagram of a predetermined device to be manufactured;
creating bill of materials information for the predetermined device;
storing said manufacturing diagram as a document on a computer readable media separate from said bill of materials information; and
linking said manufacturing diagram and said bill of materials information to one another.

5. A method as claimed in claim 4, wherein said predetermined device is a custom hearing aid.

6. A method for display of a manufacturing document for a manufacturing floor, comprising the steps of:
receiving an order for a device to be manufactured;
requesting manufacturing documents for the device to be manufactured from stored information on computer readable media;
receiving bill of materials information and a wiring diagram document for the device as separate information from at least one computer readable storage media;
displaying at least one of the bill of materials information and the wiring diagram at a computer display; and
manufacturing the device according to the displayed information.

7. A method as claimed in claim 6, wherein said device to be manufactured is a custom hearing aid.

8. A method as claimed in claim 7, wherein said bill of materials information has been updated with updated information; and
wherein said step of displaying displays the updated bill of materials information.

9. A method for updating manufacturing documents, comprising the steps of:
determining to change an item on a bill of materials for manufacturing at least one device, the change replacing a first material with a second material;
identifying all bill of materials documents that include the first material;
generating an instruction to update the bill of material information to replace the first material with the second material;
installing the update in the bill of material information without changing associated wiring diagrams; and
ensuring that the updated bill of material information is linked to associated wiring diagrams.

10. A method as claimed in claim 9, wherein said at least one device is a custom hearing aid
